(19) United States
(12) Patent Application Publication
(10) Pub. No.: US 2024/0209579 A1
(43) Pub. Date: Jun. 27, 2024

(54) Autonomous snow removal machine

(71) Applicant: Rajeev Thakur, Novi, MI (US)

(72) Inventor: Rajeev Thakur, Novi, MI (US)

(21) Appl. No.: 18/537,801

(22) Filed: Dec. 13, 2023

Related U.S. Application Data
(60) Provisional application No. 63/434,511, filed on Dec. 22, 2022.

(51) Int. Cl. E01H 5/09; E01H 10/00; G05D 1/222; G05D 1/246; G05D 1/648

(52) U.S. Cl. CPC E01H 5/098; E01H 10/007; G05D 1/222; G05D 1/246; G05D 1/648; A01D 34/008

(57) ABSTRACT

This invention relates to an autonomous snow removal machine for residential use. The machine is created by converting a manually operated snowblower to electric operation using motors, sensors, and a small computer. Key functions like wheel movement, chute control, and auger engagement are now powered by electric motors, while the auger rotation remains driven by the original gas engine or electric motor. Onboard sensors provide data to the control computer, enabling autonomous snow clearing within a defined area. The user interacts with the machine through a smartphone application to define the clearing zone and initiate the autonomous process. The machine can be operated manually when required by disengaging the clutch mechanism at the wheels and other electric motors.

### PRIOR ART

This invention addresses the need for an autonomous snow removal system that overcomes limitations present in existing technologies. These limitations include:

1. Limited range and duty cycle due to battery power: Prior inventions, such as the one described in US20190003137A1, rely solely on battery power, restricting the operational range and duration.

2. Dependence on static sensors: Certain designs, like the one in US20190003137A1, require static sensors installed in the operating area for localization. This limits the robot's applicability and flexibility.

3. Multi-functionality compromising efficiency: Attempts to create robots with multiple functions, such as snow removal and other tasks, often result in reduced effectiveness in each individual function.

4. Limited operating environments: Some robots, like the one in US20030028993A1, are specifically designed for indoor use or restricted areas like warehouses or homes, limiting their practicality for broader snow removal applications.

5. Static sensors for guidance: The robot described in US20210341566A1 requires static sensors placed above ground for navigation, adding complexity, and limiting its adaptability to different environments.

This invention aims to overcome these limitations by providing an autonomous snow removal system that is:

1. Powered by a hybrid system: Combining electric motors with a gas engine for the auger rotation allows for longer operation and wider range.

2. Self-reliant for localization: Utilizing onboard sensors and pre-stored map data eliminates the need for static sensors, enhancing flexibility.

3. Dedicated to snow removal: Focusing solely on snow removal optimizes performance and efficiency for this specific task.

4. Designed for outdoor environments: Capable of operating effectively in various weather conditions and terrains.

5. Independent of physical markers: Navigates autonomously without requiring external guidance markers, increasing its adaptability.

This invention offers a significant advancement in autonomous snow removal technology by addressing the shortcomings of existing solutions and providing a robust, efficient, and versatile system for residential and other applications.

### BACKGROUND OF THE INVENTION

Snow removal from sidewalks, driveways, parking lots, roads and other such places is a waste of time, tiring, inconvenient, with a danger of slipping and falling or having a heart attack for many old and fragile people. Many people hire expensive annual snow removal services to avoid having to clear the snow themselves.

Autonomous machines that are in the market tend to be fully electric and are expensive. Many of them also involve installation of special equipment on the property, such as underground wires or multiple poles with sensors that provide an onboard sensor with its location on the property.

Machines which rely on battery power have limited range. They are ok for small property lots but will need frequent battery changes for bigger lots. This can be a huge inconvenience to the user.

Developing a new snowblower design is also a large undertaking that takes a lot of time and resources. In this invention, a method and architecture are designed to take an existing manual snowblower design and make it autonomous.

The concept can further be extended to farming equipment—which tends to be gas driven—as they are power hungry huge machines. Here also electric motors can be used only to steer and control the various attachments that are used in the application.

One could also see this concept extended to road making bulldozers, street cleaning machines and other power-hungry applications.

The core problem is the limitation of battery powered devices—they are less powerful. They have low peak power and need frequent recharging than those powered by gas/diesel/propane or other fossil fuels. Snow removal machines of various designs are numerous. Converting them to autonomous machines which typically need electric power and can be digitally controlled is a difficult problem. Many inventors try to make the whole machine and every attachment of it electric powered and this makes the device expensive to develop and market.

In this invention, the problem is solved by only making the steering, movement, and apparatus controls electric. The power-hungry business of removing and pushing the snow is retained with gas-powered engines. The invention can also be extended to fully electric snowblower designs if the battery power is not a limitation for the area to be cleared of snow.

In the prime invention example of a single stage, gas powered snowblower—the wheels, the chute and the engagement of the auger is electrically controlled; the forward movement of the auger—which takes in the snow and throws it out through the chute is done through the gas engine. It is also possible that when the autonomous snowblower is moving forward to remove the snow, a small amount of power to the rear wheels is from the electric engine—while the rear wheel is also being pulled primarily by the auger rotation—which is done by the gas engine. The rear wheels are engaged and driven by electric motors when needed to steer.

In simple terms, there are two parts to making an autonomous moving machine -one is providing power for movement of the machine and its attachments, the second is sensing the environment to create the needed navigation and movement path—which is sent to the actuators of the machine. The actuators are easy to control when they are electric—giving digital control. All previous solutions have followed the development path of making the power for movement and control fully electric. This has made the development difficult, expensive, and unsatisfactory.

In this invention, the autonomous machine is divided into three parts—power to shovel the snow by rotating the auger which is retained by the gas engine; power to move, steer and control the attachments—this is made into electric; the third part is sensing, perception and control with electric power. This concept makes the invention unique.

In previous solutions, the entire autonomous snowblower is electric. Gasoline or other traditional fuels are not used at all. The augur which gathers the snow and pushes into the chute is driven by electric power; the wheels of the machine are driven by an electric motor; the chute which throws the snow out is rotated by electric power. The machine has cameras, global positioning sensors and other sensors to sense the environment and develop a path to move using a computer.

The drawback of this solution is the battery power—which has low life and low peak power. The machine needs to be frequently charged; the snow cannot be thrown too far to the side—as the power available is limited. This confines the operating zone and efficiency to at best a small driveway and sidewalk—when the snow level is a few inches on the ground.

### SUMMARY OF THE INVENTION

This invention describes an autonomous snow removal machine designed to self-operate using sensors, an edge computer, and a pre-stored map for navigation and snow clearing. It repurposes a standard snowblower by replacing its manual controls with electric motors powered by batteries and controlled by an onboard edge computer. The edge computer receives sensor data and sends instructions to the electric motors to operate key functions like wheel movement, chute control, deflector control, and auger engagement. The machine utilizes a pre-stored map of the area, created when snow is absent, to identify its location and boundaries during operation. Additionally, it offers the flexibility of manual operation when needed by disengaging the clutch mechanism. This invention presents a significant advancement in snow removal technology, offering increased efficiency, safety, and convenience as compared to traditional methods.

### BRIEF DESCRIPTION OF DRAWINGS

FIG.1 describes an example of manually driven single stage snowblower, which is later modified to an autonomous snow removal machine. Many such designs exist with small variations in features.

The design has two rear free spinning wheels 1 which rotate when the handle 4 is manually pushed. It has a bar 3 for rotating the auger when engaged. It has a manually rotated handle 2 for turning the chute 20. It has a gas engine 16 for providing power to rotate the auger 18 through the belt drive mechanism 19. It has an electric start button 17 to start the gas engine. It has an engine start string 21—which can be pulled to start the gas engine. The human driver uses the described machine to start the snow blower, push and steer the machine over the snow and clear the snow from one area to another. He uses his eyes to see, hands to push and turn and intelligence to decide when to do what.

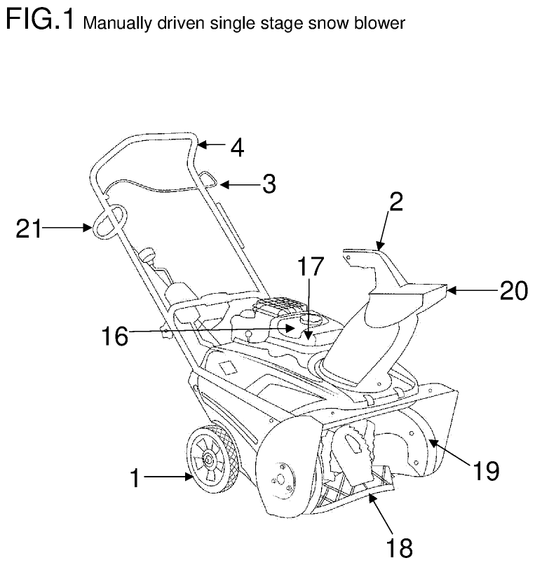

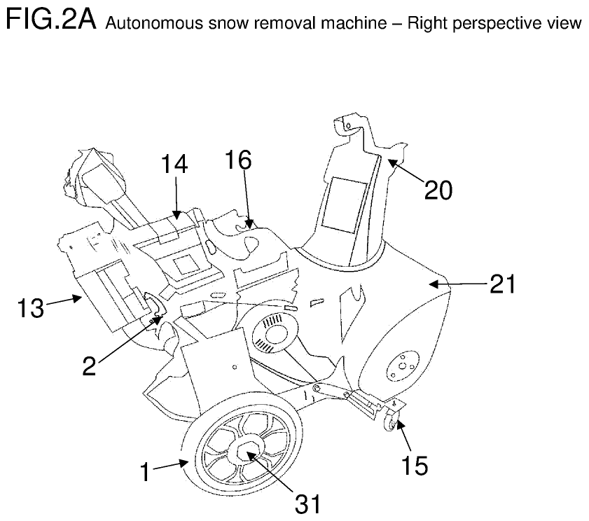

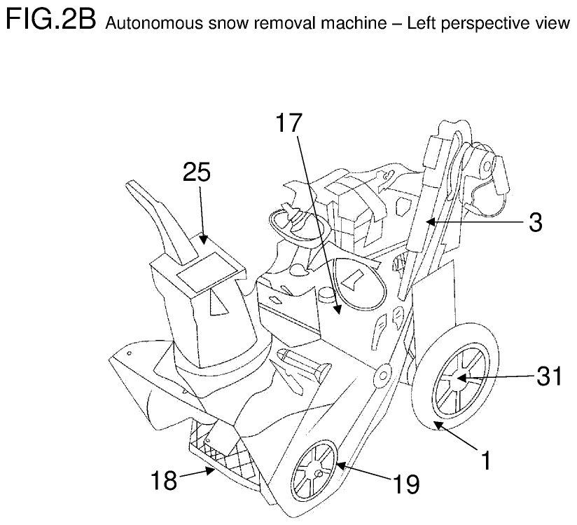

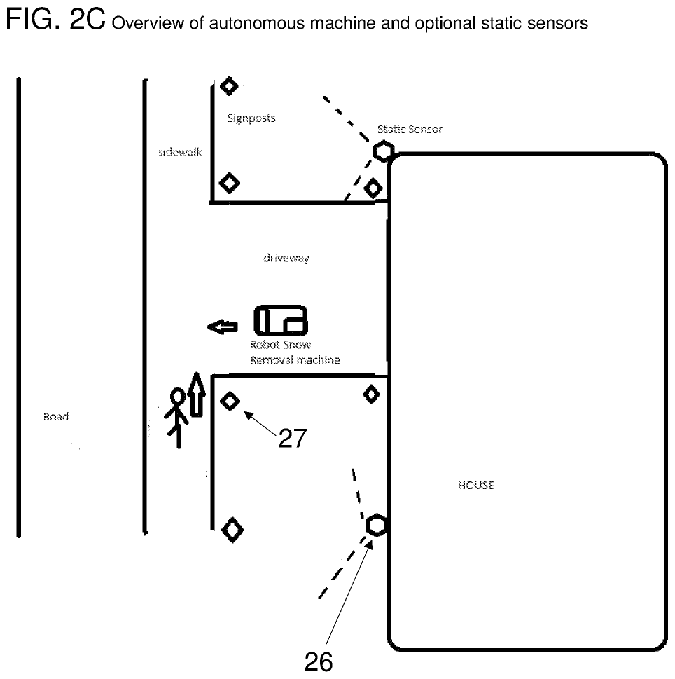

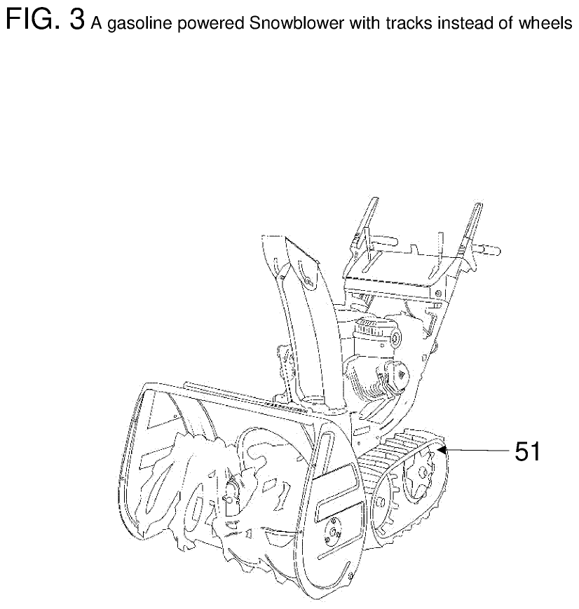

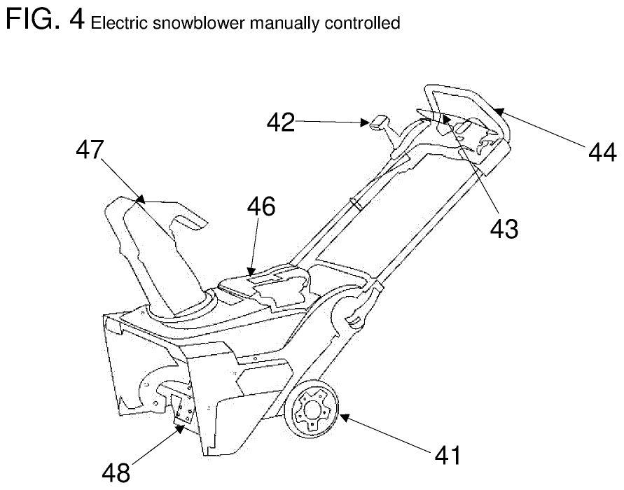

FIG. 2A, FIG. 2B and FIG. 2C describe an autonomous snow removal machine that is modified from the design example in FIG.1.

The invention has two rear wheels 1 powered directly by DC motors. The DC motors for the rear wheels 1 are powered by a DC battery 13. The DC motor drive is attached to the wheel with a clutch mechanism 31 that can be disengaged manually when needed for placing the machine at start position outside on the driveway. It has a gas engine 16 to power the rotation of the auger. It has a belt drive mechanism 19 to transfer power from the gas engine in the rear to the auger in the front. The belt drive mechanism 19 is engaged through a linear actuator 3 which is electrically powered by a DC battery 14. It has chute 20 which is rotated to desired direction by a worm gear drive that is powered through a DC motor 2. The chute control DC motor 2 is powered through battery 14.

The deflector 25 is moved up and down with an electric powered linear actuator. This allows the snow to be thrown at a high or low trajectory when it leaves chute 20. It has small swivel wheels in the front 15 that are attached to the bottom of the snow bucket 21 that encloses the auger. The swivel wheels lift the snow bucket by a small amount to from the ground to enable movement of the machine. It has an electric start device 17 that is controlled by the onboard edge computer module. It has camera sensors facing the front and rear. It may have ultrasonic sensors facing the front and rear. It may also have a GPS sensor, an IMU sensor and wheel speed sensor. Many other types of sensors can be added if deemed needed. To aid the machine with additional safety and robustness in operation, static sensors 26 and signposts 27 with machine recognizable symbols can be added in the areas close to the snow removal operation.

When the device is turned on either manually or through a smartphone application program, the edge computer module senses the surroundings to determine the area from which snow must be removed and where it should be stored. The edge computer module then starts the engine with the electric start, rotates the chute to desired side, engages the auger and moves the electric powered wheels. It does this within the defined geographical area defined in the edge computer program. The front camera video is processed to determine the desired path and the rear camera when moving back or turning. The entire device moves autonomously to clear the snow from the driveway, sidewalk, or other such user defined areas.

FIG. 3 describes a variant of a manually controlled gas powered snow removal machine. Here the wheels are being replaced by tracks 51. The controls of the tracks and chute can be made to work through an edge computer. Like the modification described in FIG. 2A and FIG. 2B, all other sensors and necessary electric motors can be integrated to make this design autonomous.

FIG. 4 describes an electric powered manually controlled snow removal machine like drawing 1, except auger 48 is rotated by a motor with electric power 46. It has a handle 44 for pushing and steering manually. The manually pushed handle 42 rotates the chute 47. The manually pulled handle 43 powers the auger 48 when the human user decides to use it. Like the modification described in FIG. 2A and FIG. 2B, sensors and necessary electric motors can be integrated to make this design autonomous.

### DETAILED DESCRIPTION OF THE INVENTION

The key problem with current autonomous snowblower designs is the dependency on battery power to do all the functions—including the main function of taking the snow with the rotating auger 18 and pushing it out through chute 20. The battery typically runs out of power quickly and needs to be charged frequently. This makes the operation less efficient and reliant on operating close to the home base since it needs to return for recharging. Other problems include the sensing and localization—which means to know where it is on the driveway or sidewalk—so it can operate in a defined zone and not wander off. Current designs rely on manually placed transmitters which inform the machine of its location. The sections below describe how the current invention solves these problems.

The invention in this patent uses a gasoline engine 16 to rotate the auger 18 through the drive mechanism 19. It uses electric power to rotate the wheels 1, control the engagement of the auger 3, rotate the chute 20, move the deflector 25 up or down and power the sensors which are connected to the onboard edge computer module. With this separate use power, the main job of clearing the snow uses gasoline power which allows operation of the autonomous snowblower over a larger range and longer time.

This invention may also use onboard sensors like GPS, IMU and wheel speed sensor to localize itself—to know where it is on the driveway. The system can be made more accurate through other onboard sensors like the camera and lidar.

In one version of the invention, a smartphone application can be used to inform the snowblower of where the snow should be cleared from. The application provides GPS coordinates and helps define where the snow should be stored after it has been cleared from the indicated boundaries through the smartphone user interface. The application can also be used to inform the user of potential problems or diagnostic issues to the user from the snow removal machine.

The main advantage of the invention is to take an existing manually controlled snowblower and modify it into an autonomous snow removal machine—by only using electric power with needed mechanism changes to control the attachments—chute rotation, auger engagement and move the wheels. The main job of taking in the snow and pushing it out through the chute uses original power source—which can be gas or electric. This invention simplifies the development of autonomous snowblowers by spending more time on the sensing, steering and controls—than on how to power the auger sufficiently to make it operate efficiently and for a longer time. The previous inventions were either fully electric powered or fully gasoline powered. The electric powered devices either need a powerful battery- which still needs frequent charging or powered through a long electric cord—which could get tangled as the device traverses up and down the driveway and sidewalk to clear the snow. Gasoline powered fully autonomous snow removal machines can be envisioned, they are expected to be more expensive and complicated—since digital control through computers are more suited to electric powered devices.

It also efficiently uses various onboard sensors to localize the machine while also sensing and perceiving the surroundings to develop a cleaning path for the snowblower on the driveway and sidewalk. Previous inventions have relied on manually placed transmitters on the perimeter of the drive walk to allow localization. These are less efficient and user friendly.

In this invention sensors like a camera or lidar 26 shown in FIG. 2C may optionally be placed at a static location on the house or property to simultaneously observe the machine and other people like traffic on the sidewalk and serve as an added measure to prevent accidents and collisions between the machine and other moving objects.

As an additional option, static signposts 27 shown in FIG. 2C can be placed on the property to help navigate and localize the snow removal machine.

The invention also uses front swivel wheels 15 shown in FIG. 2A that make it easy to turn the machine.

The use of an application on the smartphone device—as described earlier, also makes this invention an advantage over other previous inventions.

The next few paragraphs describe a complete example of how the invention would work.

Disengage the clutch for the rear wheels 1 and move the autonomous snow removal machine (ASM) to the start position at the center edge of the driveway close to the garage entrance. Re-engage the clutch for the rear wheels 1. Turn on the ASM with the manual switch or using the smartphone application. In the smartphone application bring up the section to indicate the area to be cleared off the snow and where the snow is to be stored. Then, give the execute command on the application to start clearing the snow.

All the following actions are executed autonomously. The ASB edge computer module receives the instructions from the application through Wi-Fi / 5G / Bluetooth or other communication protocol. The ASM also senses the surroundings and the path in front of it using the onboard sensors to determine if it is safe to move forward. It also does a self-check of all its sensors to ensure the ASM is working well, and no problems are detected. The ASM then computes the optimum path for clearing the driveway. If it senses a problem, it sends a diagnostic code and explanation to the smartphone to inform the user and get it corrected before moving forward. The gas engine or electric motor is started by the edge computer module, the chute 20 is rotated to desired direction using the chute control motor. Deflector 25 is adjusted to the needed height up or down as determined by the edge computer module. The auger 18 is engaged by the auger control electric linear actuator 3. The rear wheels 1 are rotated by the DC motor it is attached to. The ASM is moved in the computed path and the snow is cleared from the driveway, sidewalk, and other defined areas. The sensors on board continuously sense the path, surroundings, its location and inform the edge computer. The edge computer uses the camera information to see the path, compute the edge of the sidewalk, decide which way to turn the chute, which direction to move and executes the program algorithms to execute the actions. After it has cleared all the snow from the defined areas, it moves back to the start location and informs the user through the smartphone application that it has finished the snow-blowing task. The user may then either define a new area to be cleaned or turn the machine off with the application. The user then goes out to the ASM, disengages the clutch from the wheels manually and wheels the ASM back inside to its storage location.

The manual disengagement and engagement of the clutch could be done through the smartphone application in a variation of this design. If house is large enough and a separate location for the ASM is made outside the house, one can envision the whole operation being done remotely through the smartphone application without a manual operation at the ASM to move it out and other actions defined earlier in this section.

It should be noted that the above sequence is to be done the first time when there is snow less than a few inches or no snow. This allows clear recognition of the sidewalk, driveway, road, and other boundary edges to the onboard sensors, which then create a map of the area and store it in the edge computer memory for use at all subsequent times when there may be a lot of snow and the boundaries of the sidewalk may not be clearly visible. If that is the case, the ASM uses the map in its memory along with stored identifying features in the landscape, along with its IMU, GPS and other onboard sensor to localize itself and execute the snow removal function autonomously.

As an added measure of robustness and safety, static sensors 2 shown in FIG. 2C and signposts 27 shown in FIG. 2C may be implemented to ensure safe and efficient operation. The static sensors can independently collocate the ASM, and any other moving objects close by that are headed in a collision path and stop the ASM from moving till the path is clear. The static signposts can independently aid or communicate to the ASM information to help the ASM know where it is or what to do next. An example of the signpost is to indicate the edge of the property up to which snow must be cleared.

An example of a variation is shown in FIG. 3. This gasoline powered snowblower can be modified to be an autonomous snow removal machine using the same principles described earlier. Onboard sensors, an edge computer module can be added. The tracks can be electrically driven, the Chute and other attachments can be controlled like the methods described in FIG. 2A, FIG. 2B and FIG. 2C.

Another example of a variation is shown in FIG. 4. The main difference here is that the auger is rotated with a battery powered electric motor. This electric powered snowblower can be modified to an autonomous snow removal machine using the same principles described earlier. Onboard sensors, an edge computer module can be added. The tracks can be electrically driven, the Chute and other attachments can be controlled like the methods described in FIG. 2A, FIG. 2B and FIG. 2C.

The few examples given above are not exhaustive. There are many existing manual designs to which simple modifications can be made to copy the invention described in this patent. The wheels could be of various sizes, the wheel drive mechanisms and power source can be different, the chute and auger designs can be different and of different sizes, the edge compute module can be different, the cameras and other sensors could have different specifications, the battery used to power the chute or wheels can be of different capacities and types, etc.

1. An autonomous snow removal machine that is self-operating, using sensors and an edge computer module to navigate and clear snow. Elements that comprise this machine include:
a manually controlled snowblower conversion; whereby the machine is created from a regular snowblower by replacing its manual controls with electric motors powered by batteries;
electrically driven functions, whereby key functions like wheel movement, chute control, deflector control, and auger engagement are now powered by electric motors;
edge computer control, whereby an onboard edge computer module receives data from sensors and sends instructions to the electric motors to control the machine's movements;
pre-stored map for localization, whereby the machine utilizes a map of the area, created during snowless conditions, to identify its location and boundaries;
manual mode capability, whereby the machine can be operated manually when required by disengaging the clutch mechanism at the wheels and other electric motors.

2. An autonomous snow removal machine according to claim 1, characterized by a smartphone application user interface for control.

3. An autonomous snow removal machine according to claim 1, characterized by swivel wheels in the front for easier turning.

4. An autonomous snow removal machine according to claim 1, characterized by a single battery supplying power to all electric motors.

5. An autonomous snow removal machine according to claim 1, characterized with use of different types and combinations of sensors for improved surroundings awareness.

6. An autonomous snow removal machine according to claim 1, characterized with protective enclosures for sensors, batteries, and other electronic components.

7. An autonomous snow removal machine according to claim 1, characterized with different number and size of wheels, tracks, and drive mechanisms.

8. An autonomous snow removal machine Snowblower according to claim 1, characterized with application to farming machines.

9. An autonomous snow removal machine according to claim 1, characterized with application in industrial applications.

10. An autonomous snow removal machine according to claim 1, characterized with application in lawn mowing.

11. An autonomous snow removal machine according to claim 1, characterized with application in application in clearing snow from roads, parking lots, and other paved areas.

12. An autonomous snow removal machine according to claim 1, characterized with added lights and sounds for pedestrian safety.

13. An autonomous snow removal machine according to claim 1, characterized with manual control option via the smartphone application.

14. An autonomous snow removal machine according to claim 1, with additional static sensor communication for improved location awareness.

15. An autonomous snow removal machine according to claim 1, characterized with static signs on the premises providing location information.

16. An autonomous snow removal machine according to claim 1, characterized with ability to spray salt for melting remaining snow and ice.
